(19) United States
(12) Patent Application Publication
(10) Pub. No.: US 2009/0271599 A1
(43) Pub. Date: Oct. 29, 2009

(54) METHOD FOR SETTING TO ENABLE OR DISABLE SOFTWARE FUNCTION

(75) Inventor: Yun-Liang Huang, Taipei City (TW)

Correspondence Address: J C PATENTS, 4 VENTURE, SUITE 250, IRVINE, CA, 92618, US

(73) Assignee: Inventec Corporation, Taipei City (TW)

(21) Appl. No.: 12/352,245

(22) Filed: Jan. 12, 2009

(30) Foreign Application Priority Data
Apr. 29, 2008 (TW) 97115792

(51) Int. Cl. G06F 15/177

(52) U.S. Cl. 713/1

(57) ABSTRACT

A method for setting to enable or disable a software function is provided. The method is suitable for setting each hardware relevant software function in a system to either “enable” or “disable.” First, a customized database, which includes a specification required data of the hardware to decide to enable or disable the relevant software function, is established. Then, the specification required data is read from the customized database. Afterwards, a hardware configuration key is established according to the specification required data. Finally, the hardware configuration key is written to a registry of the system, so as to set the software function to either “enable” or “disable” according to the registry.

### CROSS-REFERENCE TO RELATED APPLICATION

This application claims the priority benefit of Taiwan application serial no. 97115792, filed Apr. 29, 2008. The entirety of the above-mentioned patent application is hereby incorporated by reference herein and made a part of this specification.

### BACKGROUND OF THE INVENTION

1. Field of the Invention

The present invention generally relates to a method for enabling a software function, in particular, to a method for setting to enable or disable a software function by automatically detecting a hardware configuration.

2. Description of Related Art

Generally, in the requirements planning of a software case, most of the customers put forward possible function requirements based on maximum application requirements. However, when entering the development stage, the design of the application software have to be revised to meet the ultimate requirements of the customers due to the limitations of the hardware specification or because the providers cannot meet specific requirements.

For example, different providers have different hardware specifications, and the application software must have different designs corresponding to different hardware specifications. Or, different stock keeping units (SKUs) have different hardware configurations, and the application software automatically detects to enable or disable relevant functions, etc. Usually, based on such requirements, the application software mostly queries the basic input output system (BIOS) or the operation system for the hardware configuration. However, the customized function is not a part of the standard design, so the application software may not obtain the relevant information after querying the BIOS or the operation system. Therefore, a new version needs to be established for the application software to meet various revision requirements.

Therefore, the difficulty in the maintenance of the application software is increased. And too many software versions cost much labour to maintain, and further, the consistency among different versions is hard to sustain.

### SUMMARY OF THE INVENTION

Accordingly, the present invention is directed to a method for setting to enable or disable a software function and a computer readable recording medium thereof, which can automatically detect a specification required data of the hardware to flexibly set to enable or disable the software function.

The present invention provides a method for setting to enable or disable a software function, suitable for setting each hardware relevant software function in a system to either “enable” or “disable.” First, a customized database, which includes a specification required data of the hardware to decide to enable or disable the relevant software function, is provided. Then, the specification required data is read from the customized database. Afterwards, a hardware configuration key is established according to the specification required data. Finally, the hardware configuration key is written to a registry of the system, so as to set to the software function to either “enable” or “disable” according to the registry.

In an embodiment of the present invention, before establishing the hardware configuration key according to the specification required data, the method further includes judging whether to enable the software function according to a setting value recorded in the specification required data, so as to determine whether to read a relevant setting parameter of a corresponding hardware. When the software function needs to be disabled, the setting value is written to a corresponding position in the hardware configuration key. Otherwise, when the software function needs to be enabled, the relevant setting parameter of the corresponding hardware is read, so as to write the relevant setting parameter to a corresponding position in the hardware configuration key.

In an embodiment of the present invention, the step of reading the relevant setting parameter of the corresponding hardware when the software function needs to be enabled further includes reading the relevant setting parameter from the specification required data if the specification required data includes the relevant setting parameter. In addition, if the specification required data does not include the relevant setting parameter, the relevant setting parameter is read from the BIOS. For example, the relevant setting parameter is read from a desktop management interface (DMI).

In an embodiment of the present invention, the hardware configuration key is a string.

The present invention stores customized specification required data into the customized database according to different hardware requirements, such that through reading the customized database, it can be decided which software function needs to be enabled or disabled. Moreover, other relevant setting parameters of the software functions can be further changed through the specification required data. In this manner, the relevant software functions can be flexibly enabled according to the customers' requirements under a single software version without changing the design and support of the BIOS. Therefore, the present invention is quite convenient.

To make the above and other objectives, features, and advantages of the present invention more apparent, a detailed description with respect to the embodiments is made below in conjunction with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of processes of a method for setting to enable or disable a software function according to a first embodiment of the present invention.

FIG. 2 is a schematic view of processes of a method for setting to enable or disable a software function according to a second embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Generally speaking, machines of the same type may have many extension series, so different stock keeping units (SKUs) are required, and accordingly the hardware configurations are different. Therefore, in order to meet various customers' requirements under a single software version, the present invention provides a method for setting to enable or disable a software function. To make the content of the present invention more comprehensible, embodiments are described hereinafter for implementation of the present invention.

For convenience of illustration, in the following embodiments, for example, an application software is installed for setting to enable or disable a software function. The application software is, for example, written by programming languages such as C language and Java language, so as to achieve the enable of disable of the software function in an electronic automatic manner. However, it should be regarded as limitations of the present invention.

### The First Embodiment

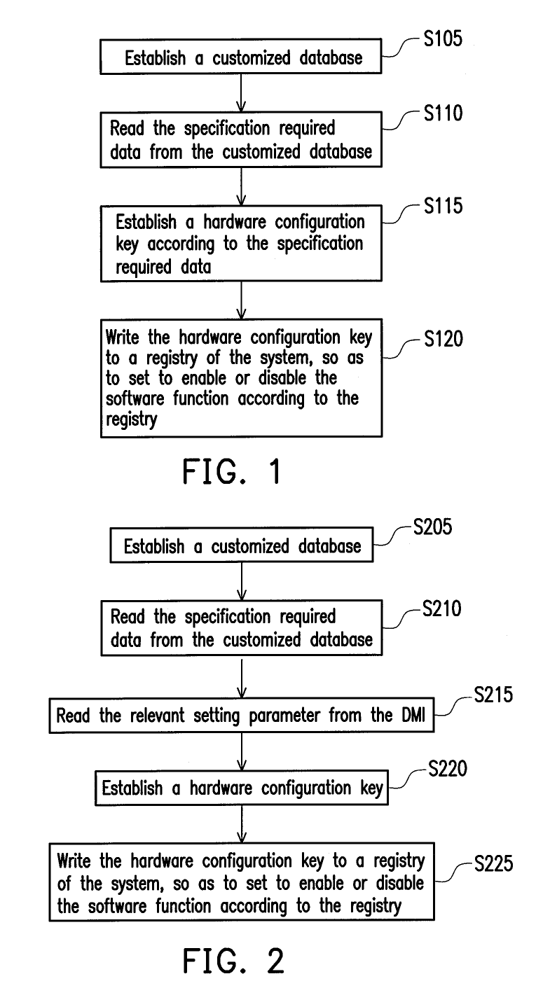

FIG. 1 is a schematic view of processes of a method for setting to enable or disable a software function according to a first embodiment of the present invention. Referring to FIG. 1, first, in step S105, a customized database is established. The customized database is set according to different hardware requirements (e.g., different SKUs), which includes specification required data of different hardware to determine whether to enable the relevant software function of the hardware in a system.

Further, the specification required data records respective setting values and relevant setting parameters of multiple hardware. The setting value is used to determine whether to enable or disable the software function. For example, if a setting value of a certain device on a corresponding universal serial bus (USB) in the specification required data, e.g., TV or wireless local area network (WLAN), is 0, it denotes that the software function of this device in the system is not expected to be enabled. The relevant setting parameter is, for example, hardware configuration of each hardware, and is used to determine which behaviour of the relevant software function corresponding to the hardware need to be changed.

Then, after the customized database is established, as shown in step S110, the application software reads the specification required data from the customized database. For example, during the installation of the application software, the application software reads the specification required data from the customized database, so as to decide which software function needs to be enabled or disabled according to the setting value recorded therein.

Afterwards, in step S115, the application software establishes a hardware configuration key according to the specification required data. The hardware configuration key is, for example, a string that conforms to a registry format of the system, and is used for the application software to parse the content of the string. The hardware configuration key includes setting values of each hardware in the specification required data and the relevant setting parameters of those hardware.

For example, if the setting value is 0, it denotes that the relevant software function needs to be disabled; and if the setting value is 1, it denotes that the relevant software function needs to be enabled. Moreover, it is assumed that the setting values in the registry are preset to be 1.

When reading the specification required data, the application software judges whether the setting value is 0 or 1. When the setting value is 0 (i.e., the software function needs to be disabled), it is only required to write the setting value to a corresponding position in the hardware configuration key. Because the software function needs to be disabled, other relevant setting parameters will not be considered. In contrast, when the setting value is 1 (i.e., the software function needs to be enabled), the relevant setting parameter of the hardware is read, so as to write the relevant setting parameter to a corresponding position in the hardware configuration key. In this embodiment, the specification required data includes relevant setting parameter of the hardware, so the application software writes the relevant setting parameter read from the specification required data to the corresponding position in the hardware configuration key.

Finally, as shown in step S120, the application software writes the hardware configuration key to a registry of the system, such that the application software sets to enable or disable the software function according to the registry. Generally speaking, the registry is used to store various data of the system, including software configuration, hardware configuration, and status information. Each time the system is booted, the registry is loaded into a memory, such that the application software can perform various settings according to the registry when being executed.

In addition, in other embodiments, the specification required data can merely have the setting values recorded therein, which will be described hereinafter in another embodiment.

### The Second Embodiment

FIG. 2 is a schematic view of processes of a method for setting to enable or disable software function according to a second embodiment of the present invention. Referring to FIG. 2, steps S205 and S210 of this embodiment are respectively the same as or similar to steps S105 and S110 of the first embodiment, and the details will not be repeated herein. This embodiment differs from the first embodiment in terms that the customized database of this embodiment only records the setting values of multiple hardware, without including corresponding relevant setting parameters.

Then, after querying the specification required data in the customized database to get the information about whether the software function will be enabled or not, as shown in step S215, the application software reads the relevant setting parameter corresponding to the software function from the desktop management interface (DMI) of the BIOS.

In detail, after obtaining the specification required data, the application software judges whether to enable or disable the software function according to the setting value. When the software function needs to be enabled, as the specification required data does not include the corresponding relevant setting parameter, the application software reads the relevant setting parameter corresponding to the software function from the DMI of the BIOS. Further, when the software function needs to be disabled, it is not required to read the relevant setting parameter.

Afterwards, in step S220, the application software establishes a hardware configuration key. For example, the relevant setting parameter corresponding to the software function that is to be enabled, and the setting values of the disabled software functions are written to corresponding positions in the hardware configuration key. Finally, as shown in step S225, the application software writes the hardware configuration key to the registry of the system through parsing the content of the hardware configuration key. In this manner, the software function can be set to be enabled or disabled according to the registry, thus achieving the customized requirements.

To sum up, in the above embodiments, when being installed on different hardware requirements, the application software automatically detects the specification required data of the hardware, so as to establish different and specific hardware configuration keys and write them to the registry. Thus, the application software can correctly determine how to process various different requirements merely by reading a specific hardware configuration key from the registry. In the software design, only the customized database needs maintenance, thus achieving the purpose of developing a single version, and reducing the software maintenance cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for setting to enable or disable a software function, suitable for setting a hardware relevant software function in a system to either “enable” or “disable,” comprising:
establishing a customized database, comprising a specification required data of the hardware;
reading the specification required data from the customized database;
establishing a hardware configuration key according to the specification required data; and
writing the hardware configuration key to a registry of the system, so as to set the software function to either “enable” or “disable” according to the registry.

2. The method for setting to enable or disable a software function according to claim 1, before the step of establishing the hardware configuration key according to the specification required data, further comprising:
judging whether to enable the software function according to a setting value recorded in the specification required data, so as to determine whether to read a relevant setting parameter of the hardware.

3. The method for setting to enable or disable a software function according to claim 2, wherein the step of judging whether to enable the software function comprises:
writing the setting value to a corresponding position in the hardware configuration key when the software function needs to be disabled.

4. The method for setting to enable or disable a software function according to claim 2, wherein the step of judging whether to enable the software function comprises:
reading the relevant setting parameter of the hardware to write the relevant setting parameter to a corresponding position in the hardware configuration key when the software function needs to be enabled.

5. The method for setting to enable or disable a software function according to claim 4, wherein the step of reading the relevant setting parameter of the hardware when the software function needs to be enabled further comprises:
reading the relevant setting parameter from the specification required data, if the specification required data comprises the relevant setting parameter; and
reading the relevant setting parameter from a basic input/output system (BIOS), if the specification required data does not comprise the relevant setting parameter.

6. The method for setting to enable or disable software function according to claim 5, if the specification required data does not comprise the relevant setting parameter, further comprising:
reading the relevant setting parameter from a desktop management interface (DMI) of the BIOS.

7. The method for setting to enable or disable software function according to claim 1, wherein the hardware configuration key is a string.
